(19) United States
(12) Patent Application Publication
(10) Pub. No.: US 2026/0151932 A1
(43) Pub. Date: Jun. 4, 2026

(54) CERAMIC THREE-DIMENSIONAL PRINTING USING SELECTIVE CHEMICAL CURING

(71) Applicant: KOREA INSTITUTE OF INDUSTRIAL TECHNOLOGY, Cheonan-si (KR)

(72) Inventors: Dong-Hyun KIM, Busan (KR); Man Sig LEE, Yangsan-si (KR); Chungsoo KIM, Ulsan (KR); Jong Wan KO, Changwon-si (KR)

(21) Appl. No.: 18/715,089

(22) PCT Filed: Nov. 30, 2022
(86) PCT No.: PCT/KR2022/019224

§ 371 Date: May 30, 2024

(30) Foreign Application Priority Data
Nov. 30, 2021 (KR) 10-2021-0167961

(51) Int. Cl. B28B 1/00; B28B 11/24; B33Y 10/00; B33Y 30/00; B33Y 40/20; B33Y 70/00

(52) U.S. Cl. CPC B28B 1/001; B28B 11/243; B33Y 10/00; B33Y 30/00; B33Y 40/20; B33Y 70/00

(57) ABSTRACT

According to one embodiment of the present invention, provided is a three-dimensional printing method comprising: a first step of applying a ceramic composition; a second step of spraying a reaction solution at least a part of the applied ceramic composition; and a third step of irradiating the applied ceramic composition with energy so as to cure, through a chemical reaction, the region where the reaction solution has been sprayed, thereby forming a ceramic layer, wherein at least one cycle of the first to third steps is repeatedly performed on the ceramic layer, and the remaining part, excluding the part cured through the chemical reaction, is removed so as to form a three-dimensional structure.

### TECHNICAL FIELD

The present invention relates to a selective chemical curing type ceramic three-dimensional printing method characterized in that a ceramic is used as a material for three-dimensional printing and selective chemical curing is employed as a printing manner.

### BACKGROUND ART

Ceramic materials, which are a general term for non-metallic inorganic materials, have the advantages of excellent hardness, wear resistance, corrosion resistance, and heat resistance, but necessitate long processing times and high processing costs due to their inherent disadvantage associated with brittleness. In severe cases, processing costs in ceramic product processes account for 80% or more of the total cost required to manufacture ceramic products, and consequently, this practically hinders the industrial manufacturing of ceramic products with complicated shapes and has been a critical factor that restricts the application fields of ceramic materials.

3D printing (additive manufacturing (AM) in ASTM terminology) technology, for which technology development and distribution are accelerating to the industrialization levels, has made significant advance for use of polymers and metal materials, but ceramic 3D printing has been relatively underdeveloped. High melting points and the need for degreasing and sintering processes are the main factors that have slowed the development of ceramic 3D printing technology, but attempts to overcome these have been recently begun.

Existing methods for making three-dimensional lamination structures of pure ceramics are largely classified into two: stereolithography apparatus (SLA) and digital light processing (DLF) methods of using a slurry containing a photoreactive resin reacting to UV light are employed for precise shape control; and liquid deposition modeling (LDM) methods are employed in architecture and ceramics production, involving the discharge and stacking of ceramic dough that solidifies by moisture evaporation. However, among the foregoing methods, the former methods result in low solid contents and large thermal shrinkages and thus are essentially impractical for manufacturing large-sized products, and the latter methods are unfeasible in the production of precision products.

### DISCLOSURE

### Technical Problem

An aspect of the present invention is to provide a 3D printing method capable of producing large-sized products by using a ceramic material.

### Technical Solution

In accordance with an aspect of the present invention, there is provided a three-dimensional printing method, including: a first step of coating a ceramic composition; a second step of spraying a reaction liquid to at least a partial region of the coated ceramic composition; a third step of irradiating energy to the coated ceramic composition to cure a region where the reaction liquid is sprayed, through a chemical reaction, thereby forming a ceramic layer, wherein the first to third steps are repeated on the ceramic layer for at least one cycle and removing a region other than the cured region resulting from the chemical reaction to form a three-dimensional structure.

According to an embodiment of the present invention, the three-dimensional printing method may further include drying the coated ceramic composition between the first step and the second step.

According to an embodiment of the present invention, the drying of the ceramic composition and the irradiating of energy in the third step may be performed through infrared irradiation.

According to an embodiment of the present invention, the ceramic composition may contain a ceramic powder and a binder.

According to an embodiment of the present invention, the ceramic powder may include an oxide, a carbide, or a nitride containing at least one metal ion selected from the group consisting of Al³⁺, Ce³⁺, Ce⁴⁺, Zn²⁺, La³⁺, Sn⁴⁺, Fe²⁺, Fe³⁺, Zr⁴⁺, Mn²⁺, Co²⁺, Ni²⁺, Si⁴⁺, W⁴⁺, Ba²⁺, Sr²⁺ and Ca²⁺.

According to an embodiment of the present invention, the binder may include at least one selected from alginate-based, acryl-based, and cellulose-based polymers.

According to an embodiment of the present invention, the reaction liquid may be an aqueous metal cation solution.

According to an embodiment of the present invention, the reaction liquid may be an aqueous solution containing at least one metal cation selected from the group consisting of Al³⁺, Ce³⁺, Ce⁴⁺, Zn²⁺, La³⁺, Sn⁴⁺, Fe²⁺, Fe³⁺, Zr⁴⁺, Mn²⁺, Co²⁺, Ni²⁺, Si⁴⁺, W⁴⁺, Ba²⁺, Sr²⁺, and Ca²⁺.

In accordance with another aspect of the present invention, there is provided a three-dimensional printing apparatus, including: a coating member configured to coat a ceramic composition; a drying unit configured to dry the coated ceramic composition; a reaction liquid spray unit configured to spray a reaction liquid to at least a partial region of the coated ceramic composition; a light source unit configured to irradiate energy to the coated ceramic composition to cure a region where the reaction liquid is sprayed, through a chemical reaction, thereby forming a ceramic layer; and a cleaning unit configured to remove a region other than the cured region resulting from the chemical reaction to form a three-dimensional structure.

### Advantageous Effects

According to the present invention, various products ranging from large-sized products to precision products can be produced by 3D printing.

### BRIEF DESCRIPTION OF DRAWINGS

FIG. 1 is a diagram showing the sequence of a 3D printing method according to an embodiment of the present invention.

FIG. 2 is a cross-sectional diagram showing an intermediate state of a printed 3D structure according to an embodiment of the present invention.

FIG. 3 is a diagram showing an optimized computer simulation method of a coating process according to an embodiment of the present invention.

FIG. 4 shows the experimental results of drying efficiency according to the drying process of the coated ceramic composition according to an embodiment of the present invention.

### MODE FOR CARRYING OUT THE INVENTION

Since the present invention may be modified in various forms and may have various embodiments, the following exemplary embodiments are illustrated in the accompanying drawings and are described in detail with reference to the drawings. However, it should be understood that the present invention is not intended to limit specific invention forms but intended to cover all the modifications, equivalents, or substitutions belonging to the idea and technical scope of the present invention.

According to an embodiment of the present invention, a 3D printing method suitable for printing large-and medium-sized products and precision products is provided by using a ceramic as a material and employing chemical curing as a printing manner.

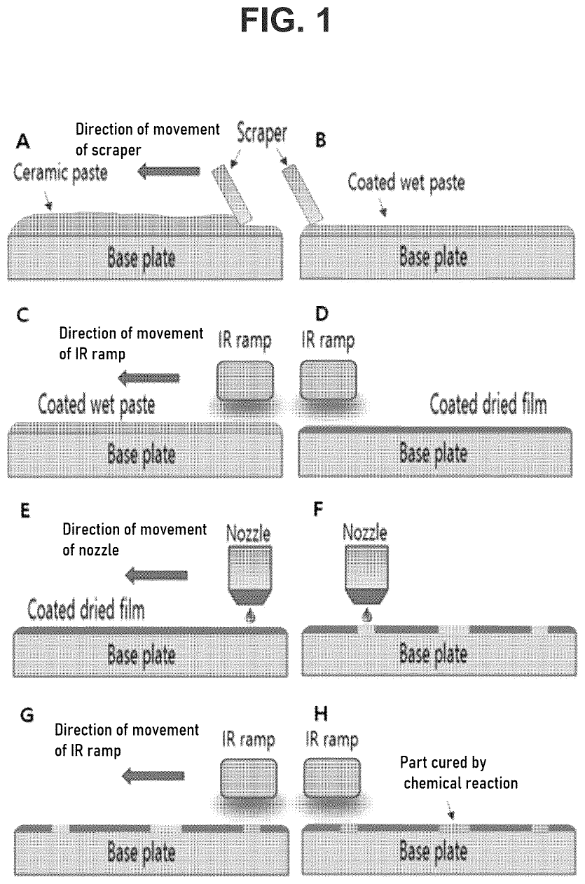

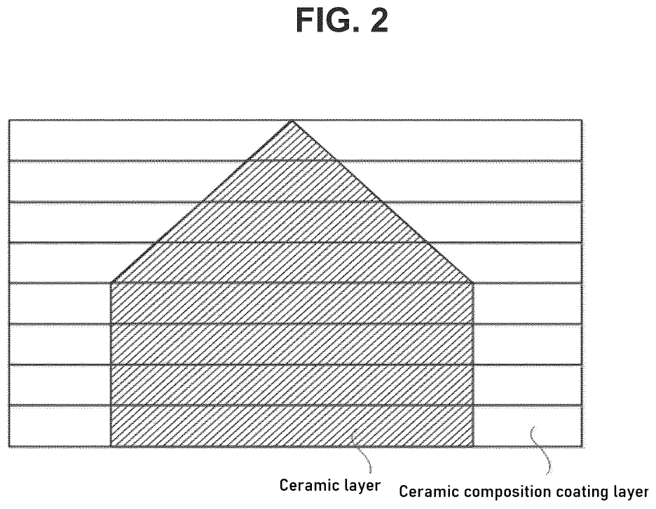

FIG. 1 is a diagram showing the sequence of a 3D printing method according to an embodiment of the present invention, and FIG. 2 is a cross-sectional diagram showing an intermediate state of a printed 3D structure according to an embodiment of the present invention.

According to an embodiment of the present invention, a three-dimensional printing method is provided, including: a first step of coating a ceramic composition; a second step of spraying a reaction liquid to at least a partial region of the coated ceramic composition; a third step of irradiating energy to the coated ceramic composition to cure a region where the reaction liquid is sprayed, through a chemical reaction, thereby forming a ceramic layer, wherein the first to third steps are repeated on the ceramic layer for at least one cycle and removing a region other than the cured region resulting from the chemical reaction to form a three-dimensional structure.

Referring to the drawings, a first step of coating a ceramic composition is first performed. The ceramic composition coated in the first step may contain a ceramic powder and a binder. The ceramic powder may include an oxide, a carbide, or a nitride containing at least one metal ion selected from the group consisting of Al³⁺, Ce³⁺, Ce⁴⁺, Zn²⁺, La³⁺, Sn⁴⁺, Fe²⁺, Fe³⁺, Zr⁴⁺, Mn²⁺, Co²⁺, Ni²⁺, Si⁴⁺, W⁴⁺, Ba²⁺, Sr²⁺ and Ca²⁺. The kind of ceramic powder may be determined considering the type and purpose of an article to be printed. If necessary, two or more kinds of ceramic powders may be mixed and used. For example, the ceramic powder may be at least one selected from the group consisting of Al₂O₃, SiO₂, ZrO₂, CeO₂, SiC, and Si₃N₄.

The ceramic powder provided in the ceramic composition may be dispersed in a liquid component. The liquid component may include at least one selected from the group consisting of water (H₂O), texanol, and butyl cellosolve. In the ceramic composition, the ceramic powder may account for 40 wt % of the total weight of the composition.

The ceramic composition may contain a binder. The binder may include at least one selected from alginate-based, acryl-based, and cellulose-based polymers. The ceramic composition may therefore be provided in a state in which the ceramic powder and binder are uniformly dispersed. The binder may be cured by a chemical reaction in a subsequent process to serve to fix the ceramic powder.

The ceramic composition may further contain an additive. The additive may be provided in an amount of 10 wt % or less of the total weight of the ceramic composition, and the type of material to be used as the additive may be at least one selected from the group consisting of citric acid, TPM, terpineol, BCA, BC, EDMAB, IPT, BHT, and DOP.

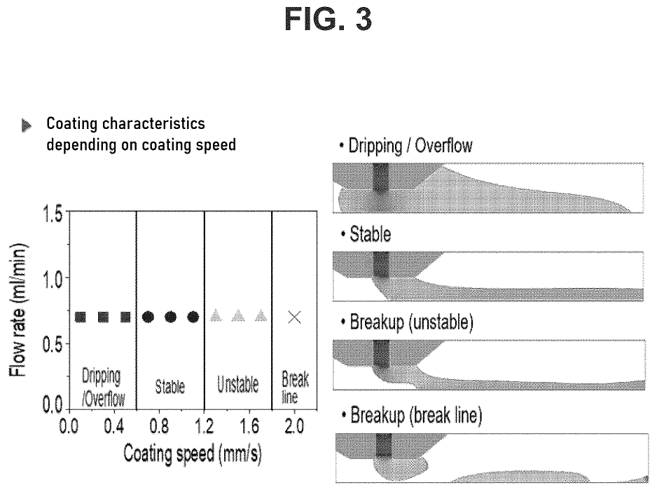

The coating method of the ceramic composition is not particularly limited. For example, the coating may be performed using a coating process, a slot die, a bar coater, an applicator, or an inkjet process. FIG. 3 shows the computer simulation experiment results on ceramic composition coating conditions using a slot die, indicating that the coating results suitable for properties of the ceramic composition can be derived through the coating process proposed in the present invention. The ceramic composition may be coated to form a layer of about 10 μm to about 1,000 μm. In the present invention, three-dimensional printing is implemented by selective curing through the spraying of a reaction liquid as described later, and thus when the coating thickness of the ceramic composition is larger than the above-mentioned range, uniform chemical curing may not be achieved in a selected region. When the ceramic composition is coated to a layer thickness of less than 10 μm, the amount of the composition provided to the layer is small, the reaction liquid sprayed may react with even a region adjacent to a desired region.

After coating the ceramic composition, the coated ceramic composition may be planarized (B in the drawing). A commonly used planarization method may be employed, and as illustrated in the drawing, the coated ceramic composition may be scraped to a uniform height using a scraper. However, this method is merely provided for an illustrative example, and the coating may be performed using screen coating, spin coating, or others.

The viscosity of the ceramic composition may be designed so as to maintain the form of a layer when the ceramic composition is coated as described above, even before curing or drying. The viscosity of the ceramic composition may be 1 Pa·s to 1,000 Pa·s. When the viscosity of the ceramic composition is less than 1 Pa·s, the ceramic composition, upon coating, may flow down without maintaining the form of a layer. In such a situation, subsequent processes may not be performed on the coated composition and may require a separate supporter to maintain the composition without flowing down. When the viscosity of the ceramic composition exceeds 1,000 Pa·s, the flowability of the ceramic composition may decrease, resulting in difficulties in the coating of the composition.

FIG. 3 is a diagram showing an optimized computer simulation method of the coating process according to an embodiment of the present invention. FIG. 3 indicates that the coating form of the ceramic composition may vary depending on the coating speed. Referring to the drawing, uniform coating can be achieved at a coating speed of the composition of 0.6 mm/s to 1.2 mm/s, but uniform coating cannot be obtained outside the range.

Unlike typical polymer compositions, the flowability of ceramic compositions may decrease due to the presence of a ceramic. It is therefore very important to improve the composition by designing the composition to have an appropriate viscosity and coat the composition uniformly by controlling the coating speed. According to one embodiment of the present invention, uniform coating can be achieved by controlling the coating speed of the ceramic composition to 0.6 mm/s to 1.2 mm/s.

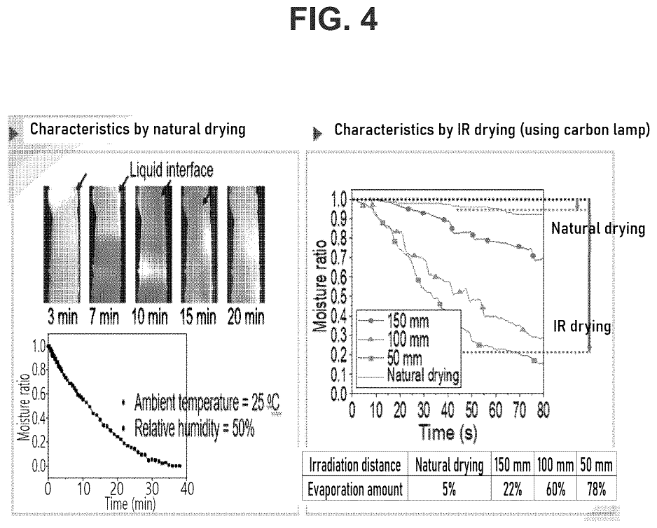

Next, a drying step may be performed on the coated ceramic composition (C and D in the drawing). In some cases, the drying step may be omitted. The drying may be performed using infrared light. Particularly, it is important that the drying step is performed to a degree that the binder does not induce a chemical reaction. The ceramic solid content in the coated layer of the ceramic composition after drying may be 30 vol % to 99 vol %. When the ceramic solid content in the ceramic composition coating layer is less than 30 vol %, a structure may be difficult to maintain in the subsequent selective curing reaction due to a low ceramic solid density. When the ceramic solid content in the ceramic composition coating layer is 99 vol % or more, the composition cannot have a sufficient flowability to induce a selective curing reaction between the binder and the reaction liquid, resulting in difficulty in achieving a three-dimensional shape. FIG. 4 shows the experimental results of drying a ceramic composition coating layer by using an infrared carbon lamp compared with natural drying, indicating that the ceramic solid content can be adjusted through a drying process proposed in the present invention. Referring to FIG. 4, the amount of moisture evaporation was only about 5 wt % even after natural drying for about 60 seconds. However, when the ceramic composition coating layer was dried by infrared irradiation at a separation distance of about 50 mm, the amount of moisture evaporation reached 78 wt % by drying for about 60 seconds, indicating that most of the moisture was removed. In the three-dimensional printing using ceramic compositions, rapid drying is needed to perform subsequent processes. It is therefore identified that IR drying performed at a specific distance can achieve three-dimensional printing using the ceramic composition according to the present invention.

Specifically, curing is to be induced in only a partial region (a region to be printed) of the ceramic composition through a selective curing reaction in a subsequent process, and thus printing an object with an accurate shape becomes difficult if the binder undergoes a chemical reaction, such as crosslinking, in the drying step. Therefore, drying may be performed by irradiating an amount of energy that does not induce a reaction. The drying process may be performed by apparatuses, such as hot air, an infrared lamp (halogen/carbon/tungsten, etc.), a microwave, and a vacuum oven. For example, drying may be performed using a carbon-based infrared lamp for 5 seconds to 10 minutes under the conditions of a surface temperature of about 50° C. to 200° C.

Next, a second step of spraying a reaction liquid to at least a partial region of the coated ceramic composition is performed (panels E and F in the drawing).

In a region where the reaction liquid is sprayed, a curing reaction occurs in the ceramic composition layer after the subsequent addition of energy or the curing time. The curing reaction may include cross-linking between binder elements or binding between metal ions to the binder. The reaction liquid may be sprayed in a form that cures a specific region of one layer, considering the type of an article to be printed.

The reaction liquid may be an aqueous metal cation solution, wherein metal cations contained in the reaction liquid react with the ceramic powder and binder contained in the ceramic composition. The above-described metal cations may be at least one type selected from the group consisting of Al³⁺, Ce³⁺, Ce⁴⁺, Zn²⁺, La³⁺, Sn⁴⁺, Fe²⁺, Fe³⁺, Zr⁴⁺, Mn²⁺, Co²⁺, Ni²⁺, Si⁴⁺, W⁴⁺, Ba²⁺, Sr²⁺, and Ca²⁺. The type of the metal cations contained in the reaction liquid does not necessarily match the type of the metal contained in the ceramic powder.

The reaction liquid may be sprayed using an inkjet head, a nozzle, or a dispenser (pneumatic, piezo, EHD, etc.). The type of spraying device and the method of spraying are not limited to the examples mentioned above. The droplet size of the reaction liquid may range from 1 picoliter to 1 milliliter. Thus, the reaction liquid may be provided in a liquid form and may have a viscosity of 5×10⁻³ Pa·s or less. The amount of metal cations in the reaction liquid may be in the range of 5 wt % to 60 wt % relative to the total composition of the reaction liquid. When the amount of metal cations added in the reaction liquid is less than 5 wt %, the selective curing reaction may not be sufficient to form and maintain a shape due to the low ion concentration. However, when the amount of metal cations in the reaction liquid is 60 wt % or more, a desired depth of curing reaction within the coating layer may not be obtained due to a rapid curing reaction on the surface when the reaction liquid is sprayed on the ceramic coating layer.

In addition, the reaction liquid may be a single or mixed phase of single molecules or polymer materials, and examples thereof may be water (H₂O), alcohol such as ethylene glycol, and acetone.

Next, a third step of irradiating energy to the above-described layer to induce the reaction is performed. After the irradiation of energy, a part where the reaction occurs by receiving energy after the spraying of the reaction liquid (a ceramic layer) and a part that is composed of a simple ceramic composition due to the non-spraying of the reaction liquid (a ceramic composition coating layer) coexist within one layer.

In such a case, the ceramic layer may have rigidity since the reaction liquid and ceramic composition are cured, and the ceramic composition coating layer may have flowability since the reaction liquid is not coated to induce no curing reaction. Thus, the execution of a cleaning process leaves the ceramic layer and removes only the ceramic composition coating layer.

As can be confirmed in FIG. 2, when the above-described first to third steps are repeated, ceramic layers are stacked one on top of another and these layers are assembled to constitute an object to be finally printed. When the first to third steps are repeatedly performed, ceramic layers and ceramic composition coating layers (parts that are not cured due to the non-spraying of the reaction liquid) surrounding the ceramic layers may coexist. A process of removing the ceramic composition coating layer is finally performed to leave only the ceramic layers stacked one on top of another, thereby finishing three-dimensional printing.

The use of this method enables three-dimensional printing by adjusting the number and thickness of layers, regardless of the size of an object to be produced. Therefore, unlike existing methods, 3D printing is possible even when an object to be produced is medium or large in size. Furthermore, unlike existing methods where a material was restricted to polymer compounds, the present invention can produce product of inorganic materials containing metals and can be used to print products in fields that require high hardness.

The above-described processes may be performed through a 3D printing apparatus. The three-dimensional printing apparatus includes: a coating member configured to coat a ceramic composition; a drying unit configured to dry the coated ceramic composition; a reaction liquid spray unit configured to spray a reaction liquid to at least a partial region of the coated ceramic composition; a light source unit configured to irradiate energy to the coated ceramic composition to cure a region where the reaction liquid is sprayed, through a chemical reaction, thereby forming a ceramic layer; and a cleaning unit configured to remove a region other than the cured region resulting from the chemical reaction to form a three-dimensional structure.

As for respective members, the coating member may be a device including a nozzle capable of coating a paste-type composition. Particularly, a member such as a brush may be further included according to the type of coating, or a device capable of spin coating may be further provided. Additionally, the coating member may further include a planarization member capable of planarizing the coated ceramic composition.

Next, the reaction liquid spray unit may include a movable nozzle. The movable nozzle may move to a region where the reaction liquid is to be sprayed, to allow the reaction liquid to be sprayed only to a specific region.

Then, the light source unit may be a member for irradiating infrared light. The light source unit may include a light source, such as an LED, capable of irradiating infrared light.

As described above, according to the present invention, large-sized products can be three-dimensionally printed by using only a coating device, a reaction liquid spray unit, and a light source unit, without a chamber. Therefore, products to be printed are not limited in size.

Although the present invention has been described with reference to the preferable exemplary embodiments of the present invention, a person skilled in the art or a person having ordinary skill in the art will appreciate that various modifications, and substitutions are possible, without departing from the scope and spirit of the invention set forth in the accompanying claims.

Therefore, it is intended that the technical range of the present invention is not limited to the detailed descriptions of the specification but should be defined by the claims.

1. A three-dimensional printing method comprising:
a first step of coating a ceramic composition;
a second step of spraying a reaction liquid to at least a partial region of the coated ceramic composition;
a third step of irradiating energy to the coated ceramic composition to cure a region where the reaction liquid is sprayed, through a chemical reaction, thereby forming a ceramic layer,
wherein the first to third steps are repeated on the ceramic layer for at least one cycle and removing a region other than the cured region resulting from the chemical reaction to form a three-dimensional structure.

2. The three-dimensional printing method of claim 1, further comprising drying the coated ceramic composition between the first step and the second step.

3. The three-dimensional printing method of claim 2, wherein the drying of the ceramic composition and the irradiating of energy in the third step are performed through infrared irradiation.

4. The three-dimensional printing method of claim 1, wherein the ceramic composition comprises a ceramic powder and a binder.

5. The three-dimensional printing method of claim 4, wherein the ceramic powder includes an oxide, a carbide, or a nitride containing at least one metal ion selected from the group consisting of Al³⁺, Ce³⁺, Ce⁴⁺, Zn²⁺, La³⁺, Sn⁴⁺, Fe²⁺, Fe³⁺, Zr⁴⁺, Mn²⁺, Co²⁺, Ni²⁺, Si⁴⁺, W⁴⁺, Ba²⁺, Sr²⁺ and Ca²⁺.

6. The three-dimensional printing method of claim 4, wherein the binder includes at least one selected from alginate-based, acryl-based, and cellulose-based polymers.

7. The three-dimensional printing method of claim 1, wherein the reaction liquid is an aqueous metal cation solution.

8. The three-dimensional printing method of claim 7, wherein the reaction liquid is an aqueous solution containing at least one metal cation selected from the group consisting of Al³⁺, Ce³⁺, Ce⁴⁺, Zn²⁺, La³⁺, Sn⁴⁺, Fe²⁺, Fe³⁺, Zr⁴⁺, Mn²⁺, Co²⁺, Ni²⁺, Si⁴⁺, W⁴⁺, Ba²⁺, Sr²⁺, and Ca²⁺.

9. A three-dimensional printing apparatus comprising:
a coating member configured to coat a ceramic composition;
a drying unit configured to dry the coated ceramic composition;
a reaction liquid spray unit configured to spray a reaction liquid to at least a partial region of the coated ceramic composition;
a light source unit configured to irradiate energy to the coated ceramic composition to cure a region where the reaction liquid is sprayed, through a chemical reaction, thereby forming a ceramic layer; and
a cleaning unit configured to remove a region other than the cured region resulting from the chemical reaction to form a three-dimensional structure.

10. The three-dimensional printing apparatus of claim 9, wherein the coating member configured to coat a ceramic composition includes at least one selected from a coating process, a slot die, a bar coater, an applicator, or an inkjet process.

11. The three-dimensional printing apparatus of claim 9, wherein the ceramic composition is coated to form a layer of 10 μm to 1,000 μm.

12. The three-dimensional printing apparatus of claim 9, wherein the drying unit configured to dry the ceramic composition comprises at least one selected from hot air, an infrared lamp, a microwave, and a vacuum oven device.

13. The three-dimensional printing apparatus of claim 9, wherein the ceramic solid content in the dried ceramic composition is 30 vol % to 99 vol %.

14. The three-dimensional printing apparatus of claim 9, wherein the reaction liquid spray unit configured to spray a reaction liquid to at least a partial region of the coated ceramic composition includes at least one selected from an inkjet head, a nozzle, and a dispenser.

15. The three-dimensional printing apparatus of claim 9, wherein in the spraying of a reaction liquid to at least a partial region of the coated ceramic composition, the droplet size of the reaction liquid ranges from 1 picoliter to 1 milliliter.
